(19) United States
(12) Patent Application Publication
(10) Pub. No.: US 2004/0094568 A1
(43) Pub. Date: May 20, 2004

(54) Packaging systems for display and distribution of products

(76) Inventor: Robert W. Dailey III, Mentor, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/615,356

(22) Filed: Jul. 8, 2003

Related U.S. Application Data
(63) Continuation-in-part of application No. 10/295,297, filed on Nov. 15, 2002.

(51) Int. Cl. A47F 1/04; G07F 11/16

(52) U.S. Cl. 221/303

(57) ABSTRACT

A packaging system for display and distribution of products is disclosed in which a container with an interior has a window capable of displaying the products in the interior and a dispenser through which the products may be selectively removed from the container. The container also has one or more angled surfaces positioned in the interior to direct the movement of products within the container toward the window or the dispenser upon removal of some of the products from within the container.

### RELATED APPLICATIONS

This application is a continuation-in-part of co-pending U.S. patent application Ser. No. 10/295,297, filed on Nov. 15, 2002, for Packaging System For Display and Distribution Of Products, the entire disclosure of which is fully incorporated herein by reference.

### BACKGROUND

This invention relates generally to the field of containers and, more specifically, to containers that provide for dispensing and viewing the contents therein.

Typically, systems for packaging products such as cloth rags or wipers include a cardboard box or other container with an openable and closeable top panel. Products are placed into the box via the top panel and the top panel is closed. The products may be discrete pieces, such as cloth rags or wipers, that an end user or purchaser may desire to remove from the box one at a time, either for purchase or for use. To inspect or remove such products from the container, the user or purchaser must open the top panel of the container.

Some packaging systems include a container with an aperture or other dispensing mechanism to enable a user or purchaser to remove one or more products from the box without opening the top panel. Other packaging systems include a container having a transparent or semi-transparent window enabling the user or purchaser to visually inspect the products prior to removing one or more products.

As individual products are removed from the container, the remaining products do not automatically move to a location nearer the aperture or the window to enable the user to easily inspect or remove products from the container. Thus, pockets of products may form within the container such that products are not easily accessible from the dispensing mechanism or visible through the window.

### SUMMARY OF THE INVENTION

The present invention provides a packaging system for display and distribution of contents, such as cloth rags and wipers or other discrete products, in which there is a container having a top, bottom, and at least one side. The container includes a window, capable of displaying the products therein, disposed in at least one side of the container, and a dispenser, through which the products may be selectively removed from the container, disposed in the bottom or the at least one side at a selected location removed from the window.

In one embodiment, the window is adjacent to the dispenser and the opening of the dispenser forms a part of the window for viewing the products. In another embodiment, the dispenser is formed as a flap that is moveable from a first position that closes the dispenser such that products are not removeable therethrough and a second position allowing removal of products via the dispenser and viewing of products through the open dispenser.

An insert having at least one inclined surface is positioned inside the container, the insert having a broad portion that rests on the bottom of the container and being tapered from that broad portion upwardly to a narrow portion. Alternatively, the container itself may have an angled portion formed integrally therewith which provides one or more inclined or angled surfaces within the container.

The products within the container are visible through the window and available for removal through the dispenser. When individual products are removed from the container through the dispenser, the remaining products are automatically forced downward by gravity, because the insert or integral angled portion provides at least one inclined surface on which the remaining products slide downwards. In this manner, the products are made available for viewing through the window and for removal through the dispenser without causing pockets of products to form in the box removed from the window or the dispenser. The degree of visibility and availability of the products for removal may depend on the location of the dispenser and window in the at least one side of the container and the geometric configuration of the insert or integral angled portion.

The invention also includes a method of displaying products, in which a container as described is positioned such that the window is viewable by a user or purchaser and the dispenser is reachable by the user or purchaser. Thus, a user or a purchaser may simultaneously inspect the products within the container and remove individual products from the container. When the container no longer contains products, then the container is disposed of.

The invention further includes a clip or the like attached to the container or formed sa part of the container for attaching the container to a frame or other structure for display of the container and the products therein.

### BRIEF DESCRIPTION OF THE DRAWINGS

FIG. 1 is a perspective view of a container in accordance with the present invention, illustrating a cubical container with a window in the front, a dispenser in the back, and a tent-shaped or vee-shaped surface therein;

FIG. 2 is a perspective view of another embodiment of the present invention illustrating a cylindrical container having a window, a dispenser, and a conical surface therein;

FIG. 3 is a perspective view of another embodiment of the present invention illustrating a cubical container having a window, a dispenser on an adjacent side, and an angled surface therein;

FIG. 4 is a perspective view of another embodiment of the present invention in which the window and the dispenser are located on the same side of a cubical container with an angled or ramp-like surface therein;

FIG. 5 is a perspective view of another embodiment of the present invention in which the inclined surfaces are part of a rectangular pyramid;

FIG. 6 is a perspective view of another embodiment of the present invention;

FIG. 7 is a perspective view of the embodiment of FIG. 6 in which the dispenser is closed;

FIG. 8 is a side elevational view of the embodiment of FIG. 6; and

FIG. 9 is a perspective view of the present invention in which a clip is available on the container.

### DETAILED DESCRIPTION

The present invention is directed to a packaging system in which products within a container are visible to a user or purchaser and may be individually selectively removed from the container by the user or purchaser. While the invention is applicable to any discrete products placed within a container, it is particularly applicable to and will be described in an exemplary manner as it relates to wipers, particularly cloth wipers.

Use of the terms “inclined” or “angled” surface or face indicate a surface that is disposed at a positive angle relative to a horizontal base or bottom of the container. The surface need not be of regular geometry and may include portions having varying curvatures. At least one portion must provide a positive angle. Use of the term “or” herein is the inclusive, and not the exclusive use. See BRYAN A. GARNER, A DICTIONARY OF MODERN LEGAL USAGE, p. 624. (2d Ed. 1995).

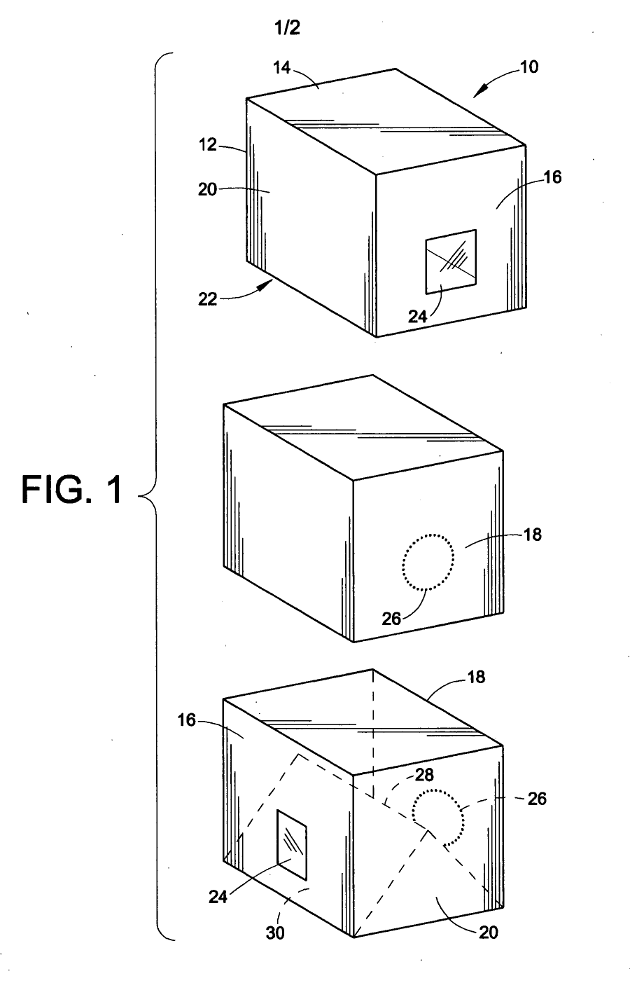

FIG. 1 illustrates an embodiment of a packaging system 10 of the present invention, in which a container 12 has a top panel 14, a front panel 16, a back panel 18, opposing side panels 20, and a bottom panel 22. These panels define an interior to the container 12. Products, such as cloth wipers, may be placed in within the interior of the container 12.

The container 12 also provides for an opening (not shown) through which products may be placed into the container 12 prior to removal of products through the dispenser 26. Preferably, this is by providing top panel 14 as an openable and closeable panel, but may also be provided by having front panel 16, back panel 18, opposing side panels 20, or bottom panel 22 to be openable and closeable, or to have an openable and closeable portion thereof, or by some other manner providing an opening into the interior of the container 12 through which products may be inserted. Provision for placement of products into the interior of the container 12 may be completed in any conventional manner without departing from the spirit or scope of the invention.

A window 24 is disposed in the front panel 16 such that the products in the interior of the container 12 may be viewed through the window 24 by the user or purchaser. The back panel 18 has a dispenser 26 disposed thereon through which products in the interior of the container 12 may be selectively removed.

An insert 28 is disposed in the interior of the container 12 to provide one or more inclined surfaces or faces 30 on which some of the products will rest after being placed in the container 12. In a preferred embodiment, illustrated in FIG. 1, the insert 28 is tent-shaped or inverted vee-shaped with a peak aligned parallel to the front panel 16 and the back panel 18. The faces 30 of the tent-shaped insert 28 are disposed at an angle relative to the planes of the front panel 16 and the back panel 18 such that, as products are selectively removed through the dispenser 26, the remaining products slide down the faces 30 of the tent-shaped insert 28 toward the window 24 and the dispenser 26.

The present invention is not limited to containers having a top panel 14, a front panel 16, a back panel 18, opposing side panels 20, and a bottom panel 22, but includes containers of any shape. Likewise, the insert 28 may be of any suitable geometric configuration to provide one or more angled or inclined faces to automatically direct the movement of products toward the window 24 or the dispenser 26 upon selective, partial removal of products through the dispenser 26. The insert 28 could be of irregular geometric configuration or include surfaces having varying curvature.

The geometric shape and placement of the insert 28 within the container 12 will depend upon the geometric shape of the container 12 and the placement of the window 24 and the dispenser 26 and may be selected without departing from the spirit or scope of the invention, so long as there is at least one inclined surface 30 that directs the products toward the window 24 or the dispenser 26 upon selective removal of some products from the interior of the container 12. The window 24 and the dispenser 26 may be located on any panel of the container, and are not limited to the front panel 16 and the back panel 18.

One of ordinary skill in the art may determine the placement and geometric configuration of the insert 28 to accommodate selectively directing product movement toward the window 24 or the dispenser 26 or both for any geometrical configuration of the container 12 without undue experimentation. The insert 28 may be of a solid geometric configuration, such as a solid triangular prism, or of a hollow configuration to provide only the angled surface 30, such as a tent-shaped configuration. Insert 28 may also have areas of varying inclination to provide more than one angled surface 30, such as illustrated in FIG. 8. FIG. 8 illustrates a relatively steep angled surface 30 at the back of the container 12 and a relatively flatter angled surface toward the front of container 112 and near the dispenser 26.

Also, insert 28 need not have a bottom surface, and it doesn't have to rest on the bottom of the container. For example, in FIG. 1, the insert 28 may be a rectangular piece of cardboard or other material folded to provide two faces 30. This is also an inverted vee shape. The folded cardboard is then inserted into the interior of the container 12 such that it rests upon the bottom panel 22 of the container 12 with the insert 28 upwardly tapered from the broad portion of the insert resting on the bottom and the inclined faces 30 providing the surfaces down which the products will slide.

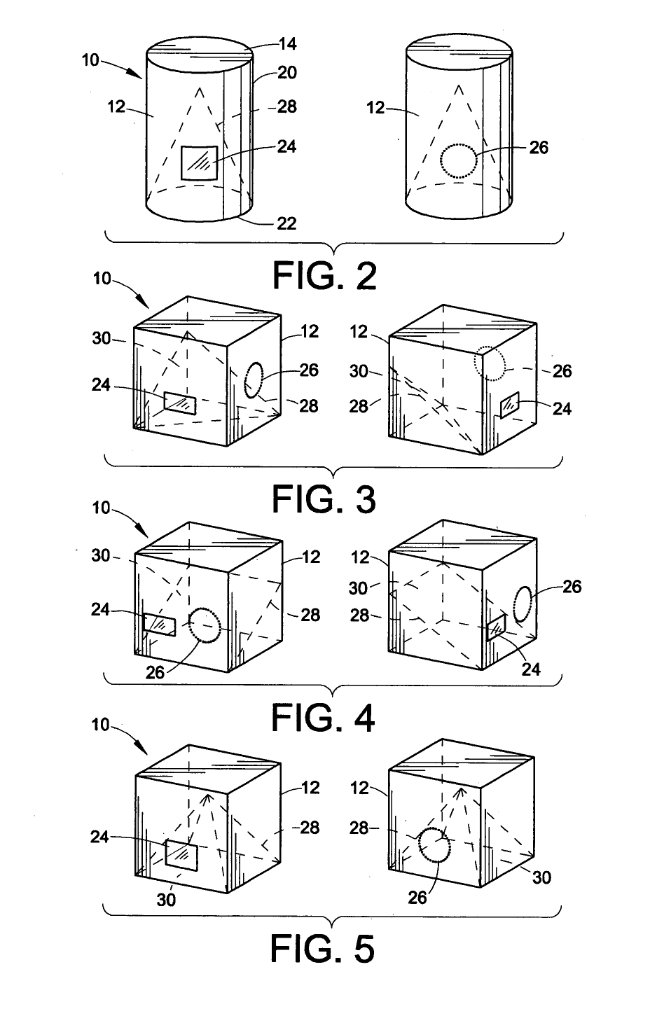

FIG. 2 illustrates another embodiment of the packaging system 10 of the present invention wherein the container 12 is cylindrical and the top panel 14 and the bottom panel 22 are circular. In this embodiment, there is a single side panel 20 that constitutes the side of the cylinder. The window 24 and the dispenser 26 are disposed in the side panel 20 at locations removed from each other. The window 24 and the dispenser 26 may be located on opposite sides of the cylindrical container 12 or may be located closely together on the side panel 20. In an embodiment in which the window 24 and the dispenser 26 are located substantially opposite each other on the side panel 20, the insert 28 is preferably conical. The insert may be provided in a tent-shaped configuration similar, to the embodiment described with respect to FIG. 1, but with a circular bottom to match bottom panel 22 or with any geometry that enables the insert to present at least one inclined surface 30 to automatically direct the movement of products after selective removal of products through the dispenser 26.

FIG. 3 illustrates another embodiment of the present invention in which the container 12 is a rectangular prism, similar to the container 12 in FIG. 1, with the window 24 and the dispenser 26 disposed on adjacent panels. In such a configuration, it would be advantageous if the insert 28 is configured with a planar triangular configuration to provide an angled surface or face 30 to direct movement of the products within the container 12 toward both the window 24 and the dispenser 26 upon selective removal of products through the dispenser 26.

FIG. 4 illustrates another embodiment of the present invention in which the container 12 is a rectangular prism, similar to the container 12 in FIG. 1, and the window 24 and the dispenser 26 are disposed on the same panel. This panel could be the front panel 16, the back panel 18, or the side panel 20. In this embodiment it is preferable to provide an insert 28 having a substantially rectangular planar configuration, or ramp-like configuration such that the angled surface or face 30 directs the movement of the products within the container 12 toward both the window 24 and the dispenser 26 upon selective removal of products through the dispenser 26.

FIG. 5 illustrates another embodiment of the present invention in which the container 12 is a rectangular prism, and the insert 28 is a rectangular pyramid, providing faces 30 to direct the movement of products toward the window 24 and the dispenser 26 upon selective removal of the products through the dispenser 26.

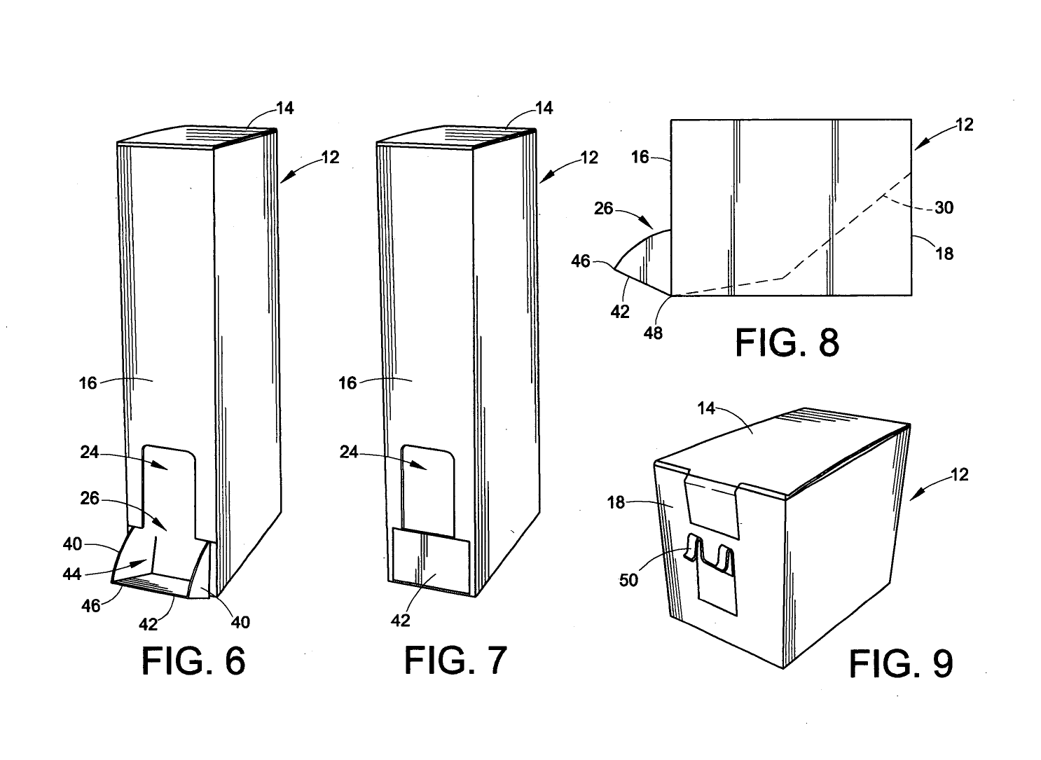

FIG. 6 illustrates an embodiment of the present invention in which the dispenser 26 is a flap that is moveable between at least two positions. One of the positions allows the removal of product from the container 12 and another position inhibits removal of product from the container 12 through the dispenser 26. The dispenser 26 is illustrated in FIG. 6 in the front panel 16, but may be disposed in the back panel 18 or a side panel 20.

In this embodiment, the dispenser 26 has opposing sides 40 and a front portion 42. When in the closed position, illustrated in FIG. 7, the front portion 42 is located in substantially the same plane as that containing the front panel 16 and forms a part thereof. The opposing sides 40 are disposed in the interior of the container 12 and are slideable to enable the front portion 42 to be displaced outwardly from the plane containing front panel 16, providing an opening in the front panel 16 through which products may be removed from the container 12.

As best seen in FIG. 8, the front portion 42 may be pivotable, such that a top 46 of the front portion 42 opens from the front panel 16 and a bottom 48 of the front portion 42 remains substantially adjacent to the front panel 16. This creates an opening 44, best seen in FIG. 6, through which the product may be seen and removed from the container 12. Preferably, gravity forces products downwardly along the angled surface 30 and at least partially into opening 44 to provide for more effective display of the products.

In another embodiment, the opposing sides 40 may slide out in a direction essentially perpendicular to the plane of the front panel 16 such that the front portion 42 remains essentially parallel to, but displaced from, the front panel 16, similar to a drawer. The front portion 42 may be displaced any distance from the front panel 16, but if the distance is greater than the size of the products in the container 12, then provision must be made so that the products do not fall from the container 12. This may take the form of providing a bottom portion to the dispenser that slides with the opposing sides 40, similar to a drawer, an extension to the bottom panel 22, or in any other form without departing from the spirit and scope of the invention.

The window 24 preferably abuts the opening 44 formed when the dispenser 26 is in the open position, as seen in FIG. 6. But the window and the dispenser need not be adjoining or even on the same panel, as discussed above.

FIG. 9 illustrates a clip 50 that is attached to the back panel 18 of the container 12. The clip 50 is configured to attached to a frame, shelf, railing, shelving, or other structure to selectively position the container 12. This will allow the container 12 to be positioned advantageously, such as for maximizing the visibility of the products within the container 12 for increasing sales thereof.

The container 12 may be made with any dimensions and size without departing from the spirit and scope of the invention.

The present invention includes a method of displaying products in which the container 12 as described above is placed in a location and positioned such that the user or purchaser may simultaneously view the products within the container 12 through the window 24 and remove products from the container 12 through the dispenser 26. Thus, a user may simultaneously inspect the products, allowing validation of the quality of the products, and remove individual products from the container. When the products have been completely removed from the container 12, the container 12 may be disposed of in any conventional manner.

The container 12 and the insert 28 may be made of any suitable material, and, preferably, the insert 28 is made from the same material as the container 12. In a preferred embodiment, the material of container 12 and insert 28 is cardboard, but any conventional material is suitable, including cardboard, paperboard, boxboard, wood, particle board, plastic, metal, or the like. It is advantageous that the insert 28 has sufficient load bearing capability to support the weight of the products to be placed in the interior of the container 12. For example, insert 28 may be made of sturdy corrugate cardboard to support the weight of the products in the interior of the container 12.

The window 24 may be of any design and material suitable to allow a user or purchaser to see the products within the container 12, and is either transparent or semi-transparent. Preferably, the window 24 is an opening in a panel of the container 12 in which a transparent or semi-transparent pane is secured, but need not have a pane. Preferably the pane is plastic, and may be acetate, mylar, polypropylene, polyvinyl chloride, or any other material that provides a transparent or semi-transparent medium through which the products in the interior of the container 12 may be viewed. The pane may be secured in the panel in any conventional manner. The window 24 may be any shape without departing from the spirit or scope of the invention. The window 24 illustrated in the Figures is rectangular.

The window 24 may be without any pane insert. In one embodiment, as discussed above, the window abuts the opening 44 formed by the dispenser 26. The window may be coextensive with the opening 44, such that the window is only present when the dispenser 26 is in an open position. The window 24 may also provided for tactile, as well as visual, access to the products in the container 12.

The dispenser 26 may be of any configuration and design allowing for selective removal of products from the interior of the container 12. In one embodiment, the dispenser 26 is a removable portion of the area of the panel of the container 12. Preferably, this removable area is defined by perforations, which allow the separation and removal of the removable portion to enable access to the products in the interior of the container 12. In another embodiment, the dispenser 26 is a hinged flap through which the products may be selectively removed from the interior of the container 12.

In a preferred embodiment, the dispenser 26 is provided as an openable flap, as discussed in greater detail above.

With a suitably configured dispenser, such as having an elastic opening that provides for insertion of a user's hand into the interior, but closes upon removal of the hand to prevent products from unintentionally leaving the interior of the container 12, the dispenser 26 even could be located on the bottom panel 22.

The dispenser 26 may be of any desired geometry without departing from the sprit or scope of the invention. As illustrated in the Figures, the dispenser 26 is circular. The geometry may be selected based upon cost, materials, convenience, or any other criteria without departing from the spirit or scope of the invention.

Another embodiment of the present invention is the integral formation of the insert 28 with the container 12 such that when the container 12 is configured for receipt of products therein, at least one inclined surface 30 is in place and attached to or part of portions of the interior of container 12. Thus, it is unnecessary to provide a separate insert 28 to place in the interior of the container 12 to provide a surface or surfaces 30 to direct the movement of the products within the container 12 upon selective partial removal of products through the dispenser 26 because the surface or surfaces 30 are integral with the container 12.

Other embodiments of the present invention include containers having more than one window 24 or more than one dispenser 26. Inserts 28 of pyramidal configuration, such as illustrated in FIG. 5, would be particularly suitable for containers having windows 24 on two adjacent panels or dispensers 26 on two adjacent panels. The window 24 or the dispenser 26 may also be located at a corner of two panels such that a portion of the window 24 or the dispenser 26 is disposed on both panels. In such a case, an inclined surface 30 similar to that illustrated in FIG. 3 would be suitable to direct the remaining products toward the corner of the container 12.

While the present invention has been illustrated by the above description of embodiments, and while the embodiments have been described in some detail, it is not the intention of the applicant to restrict or in any way limit the scope of the invention to such detail. Additional advantages and modifications will readily appear to those skilled in the art, for example, use of an alternate geometry for the container 12 or the insert 28. Therefore, the invention in its broader aspects is not limited to the specific details, representative apparatus and methods, and illustrative examples shown and described. Accordingly, departures may be made from such details without departing from the spirit or scope of the applicant's general or inventive concept.

I claim:

1. A packaging system for display and distribution of products, comprising,
a. a container having a top, a bottom, and at least one side defining an interior;
b. a dispenser, through which products may be selectively removed from the container, disposed in the at least one side; and
c. at least one inclined surface positioned in the interior;
wherein the dispenser is moveable from a first position in which the products may not be removed from the container to a second position allowing viewing of and removal of products from the container, and
whereas as products are removed, gravity forces the remaining products to displace downwardly along the inclined surface toward the dispenser.

2. The packaging system of claim 1, wherein the container has four sides, and is in the form of a rectangular prism.

3. The packaging system of claim 1, wherein the at least one inclined surface is on an insert positioned in the interior.

4. The packaging system of claim 3, wherein the insert is comprised of cardboard.

5. The packaging system of claim 1, wherein the top has an openable and closeable portion to provide an opening through which products may be placed in the interior of the container.

6. The packaging system of claim 1, where in the products are cloth wipers.

7. The packaging system of claim 1, wherein the inclined surface is integrally formed as part of the container.

8. The packaging system of claim 1, wherein the container is comprised of cardboard.

9. A packaging system for display and distribution of cloth wipers comprising,
a. a cardboard box having an openable top, a bottom, and four sides;
b. a window, capable of displaying the cloth wipers, disposed in a first side;
c. a dispenser, through which the cloth wipers may be selectively removed from the box, disposed in the first side, the dispenser movable between an open positions and a closed position;
d. an insert positioned inside the box, the insert having one edge disposed toward the top and away from the first side, the insert providing for a surface angled down toward the dispenser;
wherein the cloth wipers are visible through the window and available for removal through the dispenser and, as wipers are removed, gravity forces the remaining wipers to displace downwardly toward the window or the dispenser.

10. The packaging system of claim 9, wherein the dispenser is moveable between a first position in which the cloth wipers may not be removed via the dispenser and a second position allowing for removal of the cloth wipers.

11. A box for containing and displaying products, the box comprising:
a. A bottom panel, a first side panel, a second side panel, a front panel, and a back panel, the side panels attached to the front panel and the back panel defining an interior space of the box;
b. A window disposed in the front panel for viewing the products in the interior space; and
c. A dispenser disposed adjacent to the window in the front panel for selectively removing products from the interior space, the dispenser moveable between a first position inhibiting removal of products from the interior space and a second position allowing removal of products from the interior space.

12. The box of claim 11, further comprising at least one angled portion in the interior space configured to automatically move the products toward the window and the dispenser as products are selectively removed through the dispenser.

13. The box of claim 12, wherein the bottom panel comprises the at least one angled portion.

14. The box of claim 11, further comprising an angled insert resting on the bottom panel in the interior space, the angled insert configured to move products remaining in the interior toward the window and the dispenser as products are selectively removed through the dispenser.
